(19) United States
(12) Patent Application Publication
(10) Pub. No.: US 2015/0338551 A1
(43) Pub. Date: Nov. 26, 2015

(54) TRANSPARENT BASE

(71) Applicant: Asahi Glass Company, Limited, Chiyoda-ku (JP)

(72) Inventor: Masanobu ISSHIKI, Chiyoda-ku (JP)

(73) Assignee: Asahi Glass Company, Limited, Chiyoda-ku (JP)

(21) Appl. No.: 14/718,445

(22) Filed: May 21, 2015

(30) Foreign Application Priority Data
May 26, 2014 (JP) 2014-107924

(51) Int. Cl. G02B 1/11

(52) U.S. Cl. CPC G02B 1/11

(57) ABSTRACT

A transparent base has a first surface that is textured, and a second surface that is textured and is located on an opposite side of the transparent base from the first surface. A 20° effective reflected image diffusion index value R_{b20°} and a 45° effective reflected diffusion index value R_{b45°} used for evaluation of the first and second surfaces satisfy a relationship R_{b20°}−R_{b45°}>=0.05.

### CROSS-REFERENCE TO RELATED APPLICATIONS

This application is based upon and claims the benefit of priority of Japanese Patent Application No. 2014-107924 filed on May 26, 2014, the entire contents of which are incorporated herein by reference.

### BACKGROUND OF THE INVENTION

1. Field of the Invention

The present invention relates to a transparent base, which may be used for a cover member of a display device, or the like, for example.

2. Description of the Related Art

Generally, a display device, such as an LCD (Liquid Crystal Display) device, is provided with a cover member. This cover member is formed by a transparent base, and is arranged to protect the display device.

However, in a case in which such a transparent base is provided on the display device, when viewing a displayed image of the display device through the transparent base, reflected glare of surrounding objects or the like may often occur. When the reflected glare occurs in the transparent base, it becomes difficult for a viewer to see the displayed image, and the reflected glare may give an unpleasant or uncomfortable impression to the viewer.

Hence, in order to suppress the reflected glare, there are cases in which a surface of the transparent base is anti-glare treated (or textured).

Related art may include that proposed in Japanese Laid-Open Patent Publication No. 2012-014051, for example.

As described above, the transparent base is often anti-glare treated, in order to suppress the reflected glare caused by the surrounding light.

In the actual transparent base, there are cases in which properties such as a transmitted image clarity and a reflected image diffusion are simultaneously required, in addition to the effect of suppressing the reflected glare caused by the surrounding light.

However, in general, the transmitted image clarity and the reflected image diffusion have complementary tendencies, and it is difficult to simultaneously satisfy the two properties.

### SUMMARY OF THE INVENTION

Accordingly, it is an object in one embodiment of the present invention to provide a transparent base which can simultaneously satisfy the transmitted image clarity and the reflected image diffusion, when compared to the related art.

According to one embodiment, a transparent base includes a first surface that is textured; and a second surface that is textured and is located on an opposite side of the transparent base from the first surface, wherein a 20° effective reflected image diffusion index value R_{b20°} and a 45° effective reflected diffusion index value R_{b45°} used for evaluation of the first and second surfaces satisfy a relationship R_{b20+}−R_{b45°}>=0.05, wherein an x° effective reflected image diffusion index value R_{bx°} of a target surface that is to be evaluated, in a state in which a non-target surface that is not an evaluation target of the transparent base has been subjected to a treatment that prevents reflection of light, is computed from a formula R_{bx°}=(L_{strx°}−L_{srrx°}/L_{strx°} by irradiating light in a direction inclined by x° with respect to a thickness direction of the transparent base from the target surface side of the transparent base, measuring a luminance of a regular reflection beam reflected from the target surface, varying an acceptance angle of the regular reflection beam reflected from the target surface in a range of x−30° to x+30°, and measuring the luminance of a total reflection beam reflected from the target surface, wherein the thickness direction of the transparent base refers to a direction in which a thickness of the transparent base is taken or measured, R_{bx°} denotes an x° effective reflected image diffusion index value, L_{strx°} denotes a luminance of the x° effective total reflection beam, L_{srrx°} denotes a luminance of the x° effective regular reflection beam, and x is 20 or 45.

### BRIEF DESCRIPTION OF THE DRAWINGS

FIG. 1 is a perspective view schematically illustrating an example of a transparent base in one embodiment of the present invention;

FIG. 2 is a flow chart for generally explaining a method of acquiring a resolution index value of the transparent base;

FIG. 3 is a side view schematically illustrating an example of a measuring apparatus that is used when acquiring the resolution index value;

FIG. 4 is a graph illustrating an example of a relationship between monitored judgment result (ordinate) of a resolution level and a resolution index value T (abscissa) obtained for each transparent base;

FIG. 5 is a flow chart for generally explaining a method of acquiring a reflected image diffusion index value of the transparent base;

FIG. 6 is a side view schematically illustrating an example of a measuring apparatus that is used when acquiring the reflected image diffusion index value;

FIG. 7 is a flow chart for generally explaining a method acquiring a diffusion index value R_{bx°} of an x° (x is 20 or 45 in this example) effective reflected image at a first surface of the transparent base;

FIG. 8 is a graph illustrating a plot of a relationship (R_{b20°}, R_{b45°}), obtained for glass bases according to examples ex1 through ex12, in regions represented by R_{b20°} (abscissa) and R_{b45°} (ordinate);

FIG. 9 is a graph illustrating a relationship between the resolution index value T (abscissa) and the reflected image diffusion index value R_{b20°} (ordinate) of the effective reflected image, obtained for the glass bases according to the examples ex1 through ex12; and

FIG. 10 is a graph illustrating a relationship between the resolution index value T (abscissa) and the reflected image diffusion index value R (ordinate) of the reflected image, obtained for the glass bases according to examples ex21 through ex23.

### DESCRIPTION OF THE PREFERRED EMBODIMENTS

A description will hereinafter be given of embodiments of the present invention with reference to the drawings.

As described above, in an anti-glare treated transparent base, there are cases in which it is desirable to improve the transmitted image clarity and the reflected image diffusion. However, in general, the transmitted image clarity and the reflected image diffusion are in a tradeoff relationship. For this reason, it is presently relatively difficult to simultaneously improve the transmitted image clarity and the reflected image diffusion.

The “reflected image diffusion” is a property indicating an extent of a match of the reflected image of an object (for example, an illumination) arranged in a surrounding of the transparent base, with respect to the original object. The higher the “reflected image diffusion”, the higher the anti-glare of the transparent base.

On the other hand, according to one embodiment of the present invention, a transparent base has a first surface and a second surface on opposite sides thereof, and the first and second surfaces are textured. When a 20° effective reflected image diffusion index value R_{b20°} and a 45° effective reflected diffusion index value R_{b45°} that are obtained by the following method are used for an evaluation of each of the first and second surfaces, the following relationship (1) is satisfied.

R_{b20°}−R_{b45°}>=0.05 (1)

An x° effective reflected image diffusion index value R_{bx°} (x is 20 or 45) of a target surface that is to be evaluated, in a state in which a non-target surface that is not an evaluation target of the transparent base has been subjected to a treatment that prevents reflection of light, can be computed from the following formula (2) by irradiating light in a direction inclined by x° with respect to a thickness direction of the transparent base from the target surface side of the transparent base, measuring a luminance of a regular reflection beam (hereinafter also referred to as an “x° effective regular reflection beam”) reflected from the target surface, varying an acceptance angle of the reflection beam reflected from the target surface in a range of x−30° to x+30°, and measuring the luminance of the total reflection beam (hereinafter also referred to as an “x° effective total reflection beam”) reflected from the target surface. The thickness direction of the transparent base refers to a direction in which a thickness of the transparent base is taken or measured. In the formula (2), R_{bx°} denotes the x° effective reflected image diffusion index value, L_{strx°} denotes the luminance of the x° effective total reflection beam, and L_{srrx°} denotes the luminance of the x° effective regular reflection beam.

R_{bx°}=(L_{strx°}−L_{srrx°})/L_{strx°} (2)

Although the acceptance angle of the reflection beam reflected from the target surface is assumed to be in the range of x−30° to x+30° in this example, the acceptance angle may be set within a wider range since an amount of light monitored within the wider range is substantially zero (0), and the measured luminance of the x° effective total reflection beam L_{stx°} virtually does not change when the acceptance angle is set within the range wide that the range of x−30° to x+30°.

The present inventor found that, in a case in which only a first surface of the transparent base having the first and second surfaces is anti-glare treated and the transparent base is viewed from the first surface side, the reflected image diffusion deteriorates due the effects of the reflection from the second surface that is not anti-glare treated. In addition, based on this finding, the present inventor further found that by suppressing the reflection from the second surface of the transparent base, the reflected image diffusion can be improved for the case in which the transparent base is viewed from the first surface side.

Accordingly, in one embodiment of the present invention, the first and second surfaces of the transparent base are textured.

According to results of experiments conducted by the present inventor, in a case in which both the first and second surfaces of the transparent base are textured, it was confirmed that simultaneously improving both the transmitted image clarity and the reflected image diffusion becomes even more difficult compared to a case in which only one of the first and second surfaces is textured. For example, in the case in which both the first and second surfaces of the transparent base are textured, the reflected image diffusion may improve while the transmitted image clarity deteriorates, or an opposite behavior may be observed in which the transmitted image clarity improves while the reflected image diffusion deteriorates.

On the other hand, according to the results of the experiments conducted by the present inventor, it was confirmed that both the transmitted image clarity and the reflected image diffusion can simultaneously be improved significantly in a case in which both the first and second surfaces of the transparent base are textured so as to satisfy a predetermined condition.

Accordingly, in one embodiment of the present invention, the first and second surfaces of the transparent base are textured so as to satisfy the relationship (1) described above, using the 20° effective reflected image diffusion index value R_{b20°} and the 45° effective reflected diffusion index value R_{b45°}.

The 20° effective reflected image diffusion index value R_{b20°} of the first surface of the transparent base, in a state in which the second surface of the transparent base has been subjected to the treatment that prevents reflection of light, can be computed from the following formula (3) by irradiating light in a direction inclined by 20° with respect to a thickness direction of the transparent base from the first surface side of the transparent base, measuring the luminance of the regular reflection beam (hereinafter also referred to as an “20° effective regular reflection beam”) reflected from the first surface, varying the acceptance angle of the reflection beam reflected from the first surface in a range of −10° to +50°, and measuring the luminance of the total reflection beam (hereinafter also referred to as an “20° effective total reflection beam”) reflected from the first surface. In the formula (3), R_{b20°} denotes the 20° effective reflected image diffusion index value, L_{str20°} denotes the luminance of the 20° effective total reflection beam, and L_{srr20°} denotes the luminance of the 20° effective regular reflection beam.

R_{b20°}=(L_{str20°}−L_{srr20°})/L_{str20°} (3)

Although the acceptance angle of the reflection beam reflected from the first surface is assumed to be in the range of −10° to +50° in this example, the acceptance angle may be set within a wider range since the amount of light monitored within the wider range is substantially zero (0), and the measured luminance of the 20° effective total reflection beam L_{st20°} virtually does not change when the acceptance angle is set within the range wide that the range of −10° to +50°.

Similarly, the 45° effective reflected image diffusion index value R_{b45°} of the first surface of the transparent base, in a state in which the second surface of the transparent base has been subjected to the treatment that prevents reflection of light, can be computed from the following formula (4) by irradiating light in a direction inclined by 45° with respect to a thickness direction of the transparent base from the first surface side of the transparent base, measuring the luminance of the regular reflection beam (hereinafter also referred to as an “45° effective regular reflection beam”) reflected from the first surface, varying the acceptance angle of the reflection beam reflected from the first surface in a range of +15° to +75°, and measuring the luminance of the total reflection beam (hereinafter also referred to as an “45° effective total reflection beam”) reflected from the first surface. In the formula (4), R_{b45°} denotes the 45° effective reflected image diffusion index value, L_{str45°} denotes the luminance of the 45° effective total reflection beam, and L_{srr45°} denotes the luminance of the 45° effective regular reflection beam.

R_{b45°}=(L_{str45°}−L_{srr45°})/L_{str45°} (4)

Although the acceptance angle of the reflection beam reflected from the first surface is assumed to be in the range of +15° to +75° in this example, the acceptance angle may be set within a wider range since the amount of light monitored within the wider range is substantially zero (0), and the measured luminance of the 45° effective total reflection beam L_{str45°} virtually does not change when the acceptance angle is set within the range wide that the range of +15° to +75°.

The negative (minus, or “−”) angle defining a limit of the acceptance angle of the reflection beam indicates that the acceptance angle is located on the incident light side than a normal to the target surface (the first surface in this example) that is the evaluation target. On the other hand, the positive (plus, or “+”) angle defining a limit of the acceptance angle of the reflection beam indicates that the acceptance angle is not located on the incident light side than the normal to the target surface (the first surface in this example) that is the evaluation target.

The x° effective reflected image diffusion index value R_{bx°} (x is 20 or 45 in this example) on the second surface of the transparent base, in a state in which the first surface of the transparent base has been subjected to the treatment that prevents reflection of light, can be evaluated in a manner similar to the above.

The “treatment that prevents reflection of light” with respect to a certain surface includes blackening the certain surface by coating black ink or the like on the certain surface, for example.

By forming the texture on the first and second surfaces by the texturing so as to satisfy the relationship (1) described above, both the transmitted image clarity and the reflected image diffusion of the transparent base can simultaneously be improved significantly when compared to the conventional case.

As long as the relationship (1) described above is satisfied, the texture formed on the first and second surfaces may be similar or may be different.

(Transparent Base in One Embodiment)

Next, a description will be given of the transparent base in one embodiment of the present invention, by referring to the drawings.

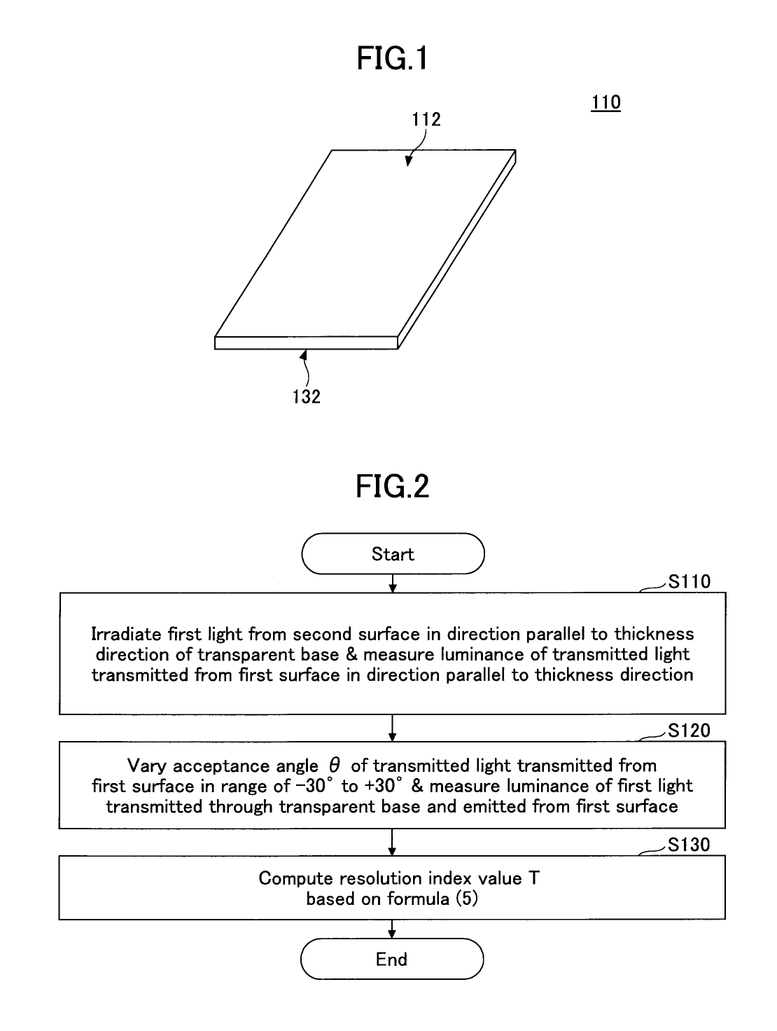

FIG. 1 is a perspective view schematically illustrating an example of the transparent base (hereinafter also referred to as a “first transparent base”) in one embodiment of the present invention.

As illustrated in FIG. 1, a first transparent base 110 has a first surface 112 and a second surface 132 on opposite sides thereof. Both the first and second surfaces 112 and 132 are textured.

The first transparent base 110 may be made of any material, as long as the material is transparent. The first transparent base 110 may be made of glass, plastic, or the like, for example.

In a case in which the first transparent base 110 is made of glass, a composition of the glass is not limited to a certain glass composition. The glass may be soda lime glass, aluminosilicate glass, or the like, for example.

In addition, in a case in which the first transparent base 110 is made of glass, the first surface 112 and/or the second surface 132 may be chemically strengthened.

The chemical strengthening refers to a generic technique to immerse a glass substrate within a molten-salt including an alkaline metal, and substituting the alkaline metal (ions) having a small ion radius and existing on an uppermost surface of the glass substrate by the alkaline metal (ions) having a large ion radius and existing within the molten-salt. According to the chemical strengthening, the alkaline metal (ions) having the ion radius larger than that of the original atom is arranged on the treated surface of the glass substrate. For this reason, a compressive stress may be applied on the surface of the glass substrate, to thereby improve the strength (particularly a breaking strength) of the glass substrate.

For example, in a case in which the glass substrate includes sodium ions (Na⁺), the chemical strengthening substitutes the sodium ions by the potassium (or kalium) ions (K⁺), for example. Alternatively, in a case in which the glass substrate includes lithium ions (Li⁺), for example, the chemical strengthening may substitute the lithium ions by sodium ions (Na⁺) and/or potassium ions (K⁺), for example.

On the other hand, in a case in which the first transparent base 110 is formed by a plastic, a composition of the plastic is not limited to a certain plastic composition. The first transparent base 110 may be formed by a polycarbonate substrate, for example.

Dimensions and a shape of the first transparent base 110 are not limited to particular dimensions and shape. For example, the first transparent base 110 may have a square shape, a rectangular shape, a circular shape, an oval shape, or the like.

In a case in which the first transparent base 110 is used as a protection cover of a display device, the first transparent base 110 is preferably thin. For example, a thickness of the first transparent base 110 may be in a range of 0.2 mm to 1.0 mm.

As described above, both the first surface 112 and the second surface 132 of the first transparent base 110 are textured.

The texture, that is, concavo-convex shapes or undulations of the first surface 112 and the second surface 132, may be formed by any suitable methods. For example, the texturing may be formed by a frosting, etching, sandblasting, lapping, silica-coating, or the like.

The texture formed on the first surface 112, when evaluated using the 20° effective reflected image diffusion index value R_{b20°} and the 45° effective reflected image diffusion index value R_{b45°} that are obtained by the above described method, is formed so as to satisfy the relationship (1) described above. The texture of the second surface 132 may be formed in a similar matter so as to satisfy the relationship (1) described above.

By forming the first surface 112 and the second surface 132 of the first transparent base 110 in this manner, it becomes possible to simultaneously improve both the transmitted image clarity and the reflected image diffusion, when compared to the conventional case.

At the first and second surfaces 112 and 132 of the first transparent base 110, an average length R_{Sm} of a surface roughness curve element on the surface is 25 μm or less, preferably 20 μm or less, and more preferably 15 μm or less. In addition, because the ability to scatter light becomes weak when the average length R_{Sm} becomes a predetermined amount smaller than the wavelength of light, the average length R_{Sm} is 1 μm or more, preferably 3 μm or more, and more preferably 5 μm or more.

At the first and second surfaces 112 and 132 of the first transparent base 110, a root mean square roughness R_{q} of the surface roughness on the surface is 0.3 μm or less, preferably 0.25 μm or less, and more preferably 0.2 μm or less. Because the ability to scatter the light becomes weak when the root mean square roughness R_{q} becomes too small, the root mean square roughness R_{q} is 0.05 pin or more, preferably 0.1 μm or more, and more preferably 0.15 μm or more.

The relationship (1) described above becomes easier to satisfy at the surface having the surface roughness described above, for the reasons described hereunder.

In the case in which the texture at the surface is sufficiently large compared to the wavelength of light, geometric optics approximation stands, and light is reflected according to local inclinations of the texture. For this reason, light is scattered to a similar extent regardless of whether an incidence angle of light is 20° or 45°, and thus, the 20° effective reflected image diffusion index value R_{b20°} and the 45° effective reflected image diffusion index value R_{b45°} become approximately the same.

On the other hand, when the texture at the surface becomes close to the wavelength of light and the geometric optics approximation no longer stands, light is scattered due to interference caused by a period of the texture, in addition to the reflection caused by the local inclination of the texture described above. For example, when the period of the texture at the surface, affecting incident light perpendicularly incident to the surface is denoted by P, the period of the texture at the surface, affecting incident light incident to the surface at an incidence angle θ becomes P cos θ. In other words, the extent of the scattering of light varies, and the 20° effective reflected image diffusion index value R_{b20°} and the 45° effective reflected image diffusion index value R_{b45°} become different, to thereby make it easier to satisfy the relationship (1) described above.

Each of the average length R_{Sm} of the surface roughness curve element on the surface, and the root mean square roughness R_{q} of the surface roughness on the surface, may be computed according to a method proposed in JIS (Japanese Industrial Standards), B0601: 2001, for example.

(Transmitted Image Clarity)

Next, a description will be given of an index representing the transmitted image clarity of the transparent base.

In this example, a “resolution index value” is used to evaluate the transmitted image clarity of the transparent base.

A description will now be given of a method of measuring the “resolution index value” that becomes a quantitative index of the transmitted image clarity, by referring to FIG. 2.

FIG. 2 is a flow chart for generally explaining a method of acquiring the resolution index value of the transparent base.

As illustrated in FIG. 2, the method (hereinafter also referred to as a “first method”) of acquiring the resolution index value of the transparent base includes steps S110, S120, and S130 that perform processes (a1), (b1), and (c1), respectively.

The process (a1) irradiates on a transparent base having a first surface and a second surface, first light from the second surface side in a direction parallel to a thickness direction of the transparent base, and measures a luminance of transmitted light (hereinafter also referred to as “0° transmitted light”) transmitted from the first surface in the direction parallel to the thickness direction of the transparent base (step S110).

The process (b1) varies an acceptance angle θ of the transmitted light transmitted from the first surface in a range of −30° to +30°, and measures the luminance of the first light (hereinafter also referred to as “total transmitted light”) transmitted through the transparent base and emitted from the first surface (step S120).

The process (c1) computes a resolution index value T based on the following formula (5), where Lₜₜ denotes the luminance of total transmitted light, and L_{t0°} denotes the luminance of 0° transmitted light (step S130).

T=(Lₜₜ−L_{t0°})/Lₜₜ (5)

In the case in which only one of the first and second surfaces of the transparent base is textured, the textured surface may be the “first surface” and the surface having no texture may be the “second surface” in the processes (a1) to (c1) of the first method.

On the other hand, in the case in which both the first and second surfaces of the transparent base are textured as in this embodiment, the first method is applied with respect to each of the first and second surfaces. In addition, a larger one of the two resolution index values that are computed may be used as a resolution index value T (Tₘₐₓ) of the transparent base.

A description will be given of each of steps S110, S120, and S130.

(Step S110)

First, the transparent base having the first and second surfaces on opposite ends thereof is prepared. As described above, the transparent base may be made of any suitable material that is transparent. In this embodiment, both the first and second surfaces of the transparent base are textured.

Next, the first light is irradiated from the second surface side of the prepared, transparent base in the direction parallel to the thickness direction of the transparent base, more particularly, in a direction of an angle θ=0°±0.5° (hereinafter also referred to as an “angle 0° direction”). The first light is transmitted through the transparent base, and is emitted from the first surface. The 0° transmitted light emitted from the first surface in the angle 0° direction is measured to obtain the “luminance of 0° transmitted light”.

(Step S120)

Next, the angle θ at which the light emitted from the first surface of the transparent base is received is varied in a range of −30° to +30°, and the luminance of the received light is measured in a manner similar to step S110. As a result, a luminance distribution of light transmitted through the transparent base and emitted from the first surface can be measured and totaled to obtain the “luminance of total transmitted light”.

(Step S130)

Next, the resolution index value T is computed based on the formula (5) described above. As will be described later, this resolution index value T is correlated to a judgment result of the transmitted image clarity viewed by an observer, and is confirmed to represent a behavior close to human visual senses. For example, the transparent base having a large (close to 1) resolution index value T has a poor transmitted image clarity, while the transparent base having a small resolution index value T has a satisfactory transmitted image clarity. Accordingly, this resolution index value T can be used as a quantitative index when judging the transmitted image clarity of the transparent base.

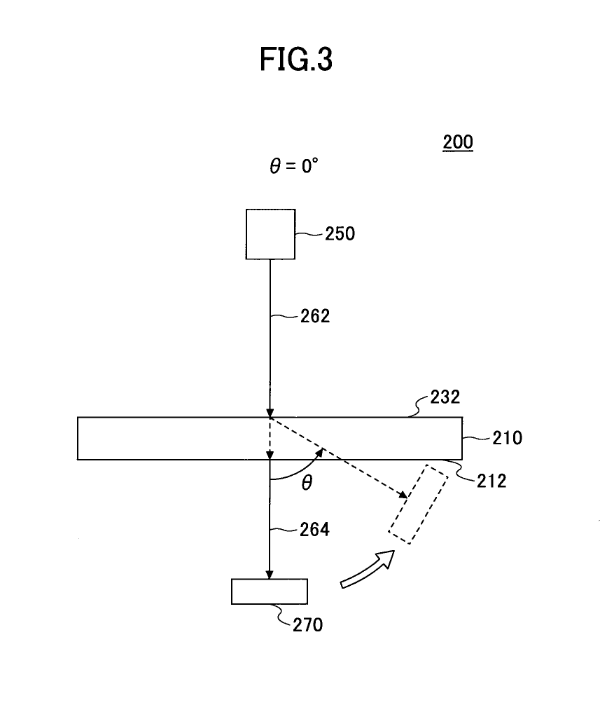

FIG. 3 is a side view schematically illustrating an example of a measuring apparatus that is used when acquiring the resolution index value T represented by the formula (5) described above.

As illustrated in FIG. 3, a measuring apparatus 200 includes a light source 250 and a detector 270, and a transparent base 210 is arranged within the measuring apparatus 200. The transparent base 210 has a first surface 212 and a second surface 232. The light source 250 emits first light 262 towards the transparent base 210. The detector 270 receives transmitted light (or transmission beam) 264 emitted from the transparent base 210, and detects the luminance of the transmitted light 264.

The second surface 232 of the transparent base 210 is arranged on the side of the light source 250, and the first surface 212 of the transparent base 210 is arranged on the side of the detector 270. Hence, the first light 262 detected by the detector 270 is the transmitted light 264 transmitted through the transparent base 210.

In this embodiment, both the first and second surfaces 212 and 232 of the transparent base 210 are textured. However, in a case in which only one of the first and second surfaces 212 and 232 of the transparent base 210 is textured, the textured surface of the transparent base 210 becomes the first surface 212. In other words, the textured surface of the transparent base 210 in this case is arranged within the measuring apparatus 200 so as to be located on the side of the detector 270.

In addition, the first light 262 is irradiated at the angle θ parallel to the thickness direction of the transparent base 210. In the following description, this angle θ is defined to be 0°. In this specification, the angle θ in a range of θ=0°±0.5° is defined as an angle of 0°, by taking into consideration an error of the measuring apparatus 200.

In the measuring apparatus 200, the first light 262 is emitted from the light source 250 towards the transparent base 210, and the detector 270 is used to detect the transmitted light 264 emitted from the first surface 212 of the transparent base 210. As a result, the 0° transmitted light can be detected by the detector 270.

Next, the angle θ at which the detector 270 receives the transmitted light 264 is varied in a range of −30° to +30°, and the transmitted light 264 is detected by the detector 270 in a manner similar to the above.

Hence, the transmitted light 264, that is, the total transmitted light, transmitted through the transparent base 210 and emitted from the first surface 212, is received by the detector 270 at the angle θ varied in the range of −30° to +30°.

The resolution index value T of the transparent base 210 can be acquired based on the formula (5) described above, using the luminance of the 0° transmitted light and the luminance of the total transmitted light that are obtained.

As described above, in the case of the transparent base having the texture formed on both the first and second surfaces thereof, the operation described above is performed with respect to each of the first and second surfaces. In addition, the larger one of the two resolution index values T that are obtained is used as the resolution index value T (Tₘₐₓ) of the transparent base.

The measurements described above may easily be performed using an existing goniometer (or goniophotometer) on the market.

(Appropriateness of Resolution Index Value T)

In order to confirm appropriateness of the resolution index value T as an index representing the transmitted image clarity, the transmitted image clarity of each of the various transparent bases is evaluated according to the following method.

First, transparent bases having an anti-glare treated first surface, treated by any suitable method, are prepared. A second surface of these transparent bases is not anti-glare treated, and thus, the second surface is a non-textured, smooth surface. These transparent bases are made of glass. Thicknesses of these transparent bases are selected from a thickness range of 0.5 mm to 3.0 mm.

In addition, a plastic standard test chart (high-definition resolution chart I type: manufactured by Dai Nippon Printing Co., Ltd.) is prepared.

Next, each transparent base is arranged above the standard test chart. Each transparent base is arranged so that the first surface thereof (that is, the anti-glare treated surface) faces a direction opposite to that of the standard test chart. A distance between each transparent base and the standard test chart is 1 cm.

Next, the standard test chart is viewed by the observer through each transparent base, in order to evaluate a limit of visible bars, LW/PH (Line Width per Picture Height). The resolution level is judged by monitoring each transparent base. A maximum value of the LW/PH of the standard test chart is 2000.

Next, a goniometer (GC500L manufactured by Nippon Denshoku Industries Co., Ltd.) is used to perform operations described above for steps S110 through S130, and the resolution index value T is computed from the formula (5) for each transparent base. In step S120, a range of the acceptance angle in the measuring apparatus 200 is set to −30° to +30°. The amount of transmitted light is substantially zero (0) for the acceptance angle ranges of −90° to −30° and +30° to +90°, and no undesirable effects are introduced by computing the resolution index value T using the acceptance angle range of −30° to +30°.

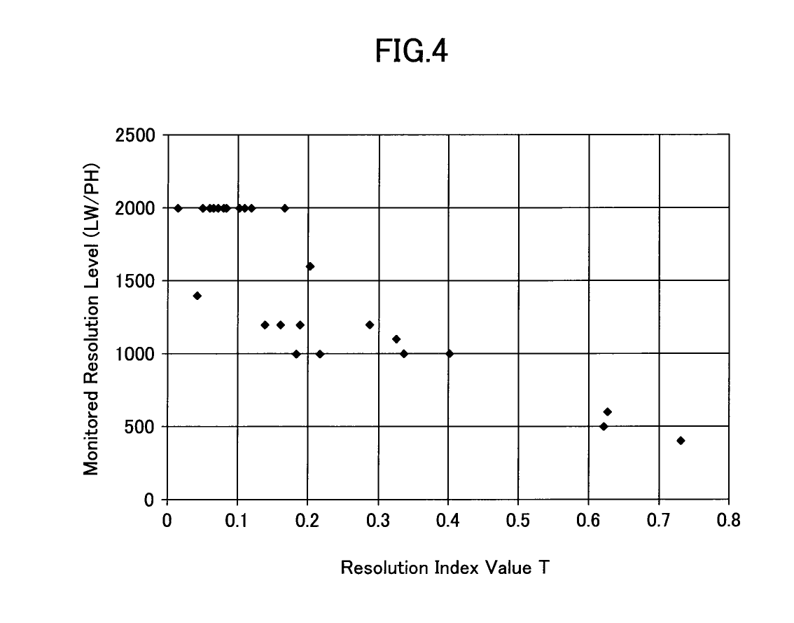

FIG. 4 is a graph illustrating an example of a relationship between the monitored judgment result (ordinate) of the resolution level and the resolution index value T (abscissa) obtained for each transparent base.

It may be seen from FIG. 4 that there is a negative correlation between the monitored judgment result of the resolution level and the resolution index value T. When the resolution index value T is in a vicinity of 0.1, the monitored resolution level is the maximum value of 2000 and saturated for a plurality of transparent bases. Because the higher the monitored resolution level the better, it is confirmed that the resolution index value T is preferably less than 0.4, more preferably less than 0.3, furthermore preferably less than 0.2, and most preferably less than 0.15.

These findings suggest that the resolution index value T corresponds to a judgment tendency of a viewer on the transmitted image clarity that is monitored, and that the resolution index value T can thus be used to judge the transmitted image clarity of the transparent base. In other words, by using the resolution index value T, it is possible to objectively and quantitatively judge the transmitted image clarity of the transparent base.

(Reflected Image Diffusion)

Next, a description will be given of an index representing the reflected image diffusion of the transparent base.

In this example, a “reflected image diffusion index value” is used to evaluate the reflected image diffusion of the transparent base.

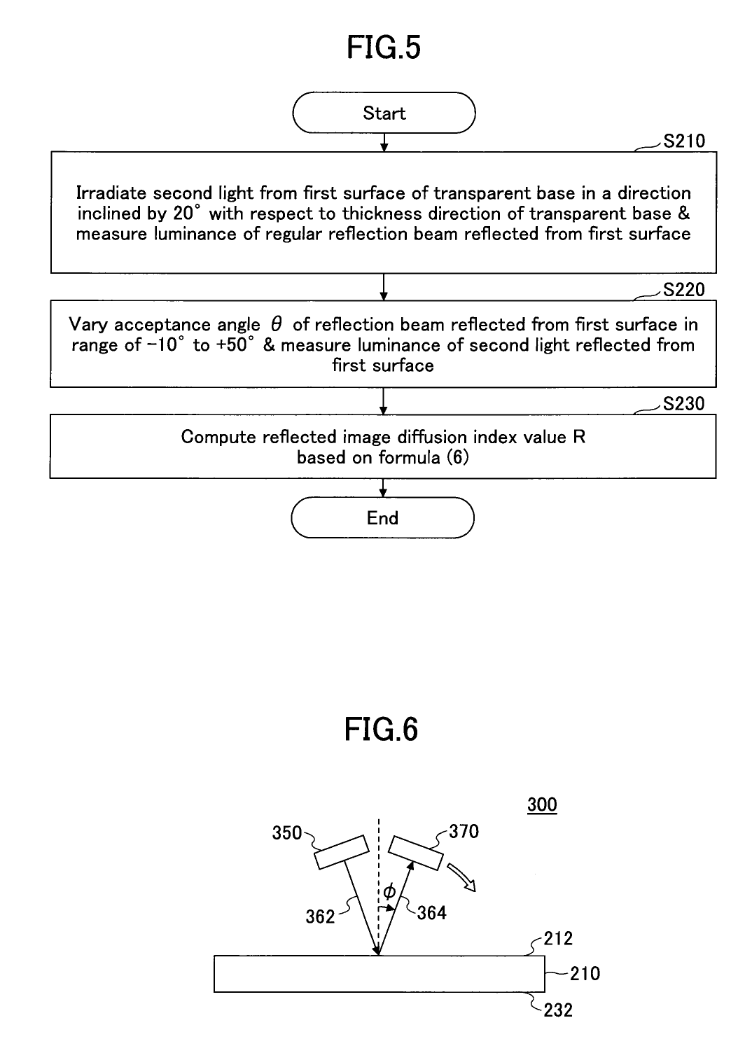

A description will now be given of a method of measuring the “reflected image diffusion index value” that becomes a quantitative index of the reflected image diffusion, by referring to FIG. 5.

FIG. 5 is a flow chart for generally explaining a method of acquiring the reflected image diffusion index value of the transparent base.

As illustrated in FIG. 5, the method (hereinafter also referred to as a “second method”) of acquiring the reflected image diffusion index value of the transparent base includes steps S210, S220, and S230 that perform processes (a2), (b2), and (c2), respectively.

The process (a2) irradiates second light from the first surface side of the transparent base having the first and second surfaces in a direction inclined by 20° with respect to the thickness direction of the transparent base, and measures the luminance of the regular reflection beam (hereinafter also referred to as a “20° regular reflection beam”) reflected from the first surface (step S210).

The process (b2) varies the acceptance angle of the reflection beam reflected from the first surface in a range of −10° to +50°, and measures the luminance of the second light (hereinafter also referred to as a “total reflection beam”) reflected from the first surface (step S220).

The process (c2) computes the reflected image diffusion index value R based on the following formula (6), where Lₜᵣ denotes the luminance of the total reflection beam, and L_{rr20°} denotes the luminance of the 20° regular reflection beam (step S230).

R=(Lₜᵣ−L_{rr20°})/Lₜᵣ (6)

In the case in which only one of the first and second surfaces of the transparent base is textured, the textured surface may be the “first surface” and the surface having no texture may be the “second surface” in the processes (a2) to (c2) of the second method.

On the other hand, in the case in which both the first and second surfaces of the transparent base are textured as in this embodiment, the second method is applied with respect to each of the first and second surfaces. In addition, a smaller one of the two reflected image diffusion index values that are computed may be used as a reflected image diffusion index value R (Rₘᵢₙ) of the transparent base.

A description will be given of each of steps S210, S220, and S230.

(Step S210)

First, the transparent base having the first and second surfaces on opposite ends thereof is prepared.

The material, composition, or the like of the transparent base may be the same as those used in step S110 of the first method described above. Hence, a description on the material, composition, or the like of the transparent base will be omitted.

Next, the second light is irradiated from the first surface side of the prepared, transparent base in a direction inclined by 20°±0.5° with respect to the thickness direction of the transparent base. The second light is reflected by the first surface of the transparent base. The 20° regular reflection beam of the reflected light (or reflection beam) from the first surface is detected, and the luminance of the detected beam is measured as the “luminance of the 20° regular reflection beam”.

(Step S220)

Next, the acceptance angle of the reflection beam reflected from the first surface is varied in a range of −10° to +50°, and the luminance of the total reflection beam reflected from the first surface is similarly measured for the varied range. The luminance distribution of the second light reflected at the first surface of the transparent base and emitted from the first surface is totaled and regarded as the “luminance of the total reflection beam”.

(Step S230)

The reflected image diffusion index value R is computed based on the formula (6) described above.

This reflected image diffusion index value R is correlated to a judgment result of the reflected image diffusion viewed by the observer, and is confirmed to represent a behavior close to human visual senses. For example, the transparent base having a large (close to 1) reflected image diffusion index value R has a satisfactory reflected image diffusion, while the transparent base having a small reflected image diffusion index value R has a poor reflected image diffusion. Accordingly, this reflected image diffusion index value R can be used as a quantitative index when judging the reflected image diffusion of the transparent base.

FIG. 6 is a side view schematically illustrating an example of a measuring apparatus that is used when acquiring the reflected image diffusion index value R represented by the formula (6) described above.

As illustrated in FIG. 6, a measuring apparatus 300 includes a light source 350 and a detector 370, and a transparent base 210 is arranged within the measuring apparatus 300. The transparent base 210 has a first surface 212 and a second surface 232. The light source 350 emits second light 362 towards the transparent base 210. The detector 370 receives reflected light (or reflection beam) 364 reflected from the transparent base 210, and detects the luminance of the reflected light 364.

In the case in which the first surface 212 of the transparent base 210 is the target surface that is the evaluation target, the transparent base 210 is arranged so that the first surface 212 thereof is located on the side of the light source 350 and the detector 370. Accordingly, in the case in which one of the two surfaces of the transparent base 210 is anti-glare treated, the anti-glare treated surface becomes the first surface 212 of the transparent base 210. In other words, in this case, the transparent base 210 is arranged within the measuring apparatus 300 so that the anti-glare treated surface is located on the side of the light source 350 and the detector 370.

In addition, the second light 362 is irradiated in a direction inclined by 20° with respect to the thickness direction of the transparent base 210. In this specification, the angle a range of 20°±0.5° is defined as an angle of 20°, by taking into consideration an error of the measuring apparatus 300.

In the measuring apparatus 300, the second light 362 is emitted from the light source 350 towards the transparent base 210, and the detector 370 is used to detect the reflected light 364 reflected from the first surface 212 of the transparent base 210. As a result, the “20° regular reflection beam” can be detected by the detector 370.

Next, the angle ø at which the detector 370 receives the reflected light 364 is varied in a range of −10° to +50°, and the reflected light 364 is detected by the detector 370 in a manner similar to the above.

Hence, the reflected light 364, that is, the luminance of the total reflection beam, reflected from the first surface 212 of the transparent base 210 is received by the detector 370 at the angle ø varied in the range of −10° to +50° and totaled.

The negative (minus, or “−”) angle defining a limit of the acceptance angle ø of the reflection beam indicates that the acceptance angle ø is located on the incident light side than a normal to the target surface (the first surface that is the evaluation target in this example). On the other hand, the positive (plus, or “+”) angle defining a limit of the acceptance angle ø of the reflection beam indicates that the acceptance angle ø is not located on the incident light side than the normal to the target surface (the first surface that is the evaluation surface in this example) that is the evaluation target.

The reflected image diffusion index value R of the transparent base 210 can be acquired based on the formula (6) described above, using the luminance of the 20° regular reflection beam and the luminance of the total reflection beam that are obtained.

As described above, in the case of the transparent base having the texture formed on both the first and second surfaces thereof, the operation described above is performed with respect to each of the first and second surfaces. In addition, the smaller one of the two reflected image diffusion index values R that are obtained is used as the reflected image diffusion index value R (Rₘᵢₙ) of the transparent base.

The measurements described above may easily be performed using an existing goniometer (or goniophotometer) on the market.

(x° Effective Reflected Image Diffusion Index Value R_{bx°})

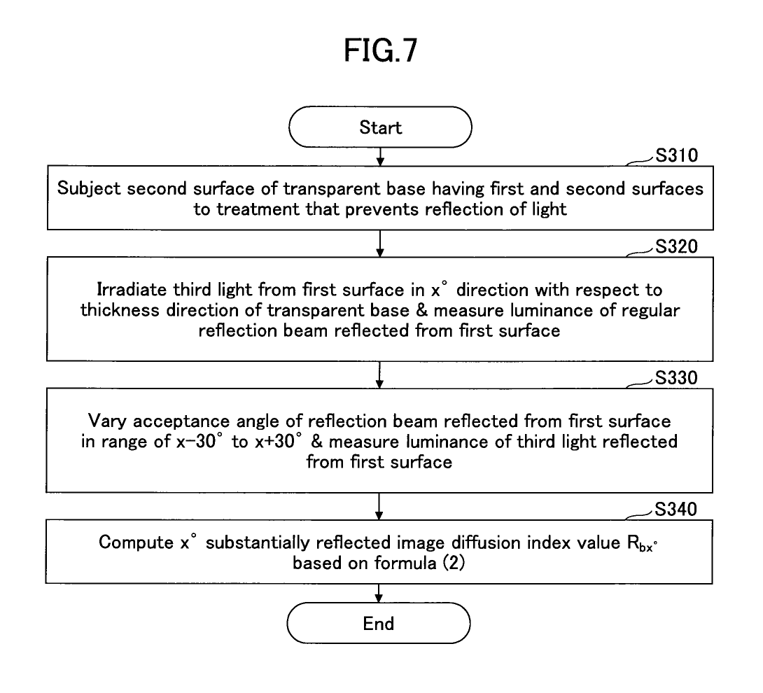

Next, a description will be given of a particular method of computing the x° effective reflected image diffusion index value R_{bx°} (x is 20 or 45 in this example), which is an index related to the texture of each of the first and second surfaces of the transparent base, by referring to FIG. 7.

As is evident from the description given heretofore, the x° effective reflected image diffusion index value R_{bx°} (x is 20 or 45 in this example) is an index capable of representing only the reflection beam at the target surface (for example, the first surface) that is the evaluation target, in a state in which the effects of the reflection at the non-target surface (for example, the second surface that is not the evaluation target) of the transparent base are substantially eliminated. As described above, when the texture at the surface becomes close to the wavelength of light, a difference is introduced between the 20° effective reflected image diffusion index value R_{b20°} and the 45° effective reflected image diffusion index value R_{b45°}, to thereby satisfy the relationship (1) described above. In other words, the x° effective reflected image diffusion index value R_{bx°} is an index that can be directly related to the shape of the target surface.

FIG. 7 is a flow chart for generally explaining a method acquiring the x° effective reflected image diffusion index value R_{bx°} (x is 20 or 45 in this example) at the first surface of the transparent base.

As illustrated in FIG. 7, the method (hereinafter also referred to as a “first method”) of acquiring the x° effective reflected image diffusion index value R_{bx°} (x is 20 or 45 in this example) at the first surface of the transparent base includes steps S310, S320, S330, and S340 that perform processes (a3), (b3), (c3), and (d3), respectively.

The process (a3) subjects the second surface of the transparent base having the first and second surfaces, to the treatment that prevents reflection of light (step S310).

The process (b3) irradiates third light from the first surface side of the transparent base in a direction inclined by x° with respect to the thickness direction of the transparent base, and measures a luminance of a regular reflection beam (hereinafter also referred to as an “x° effective regular reflection beam”) reflected from the first surface (step S320).

The process (c3) varies an acceptance angle of the reflection beam from the first surface of the transparent base in a range of x−30° to x+30°, and measures the luminance of the third light (hereinafter also referred to as “x° effective total reflection beam”) reflected from the first surface (step S330).

The process (d3) computes the x° effective reflected image diffusion index value R_{bx°} based on the formula (2) described above (step S340).

A description will be given of each of steps S310, S320, S330, and S340.

(Step S310)

First, the second surface of the transparent base is subjected to the treatment that prevents reflection of light. This treatment that prevents reflection of light is performed in order to eliminate the effects of the reflection from the non-target surfaces when performing the measurements in the following steps.

As described above, the treatment that prevents reflection of light is not limited to a particular type of treatment. For example, a black ink layer may be provided on the second surface of the transparent base, in order to prevent reflection of light at the second surface. Alternatively, other methods may be employed to prevent the reflection of light at the second surface of the transparent base.

(Step S320)

Next, the third light is irradiated from the first surface side of the transparent base in the direction inclined by x° (x is 20 or 45 in this example) with respect to the thickness direction of the transparent base, and the luminance of the x° effective regular reflection beam reflected from the first surface is measured.

For example, in the case in which the third light is irradiated on the first surface side of the transparent base in the direction inclined by 20° with respect to the thickness direction of the transparent base, the luminance of the 20° effective regular reflection beam can be measured by measuring the luminance of the regular reflection beam having undergone regular reflection at the first surface.

In addition, in the case in which the third light is irradiated on the first surface side of the transparent base in the direction inclined by 45° with respect to the thickness direction of the transparent base, the luminance of the 45° effective regular reflection beam can be measured by measuring the luminance of the regular reflection beam having undergone regular reflection at the first surface.

(Step S330)

Next, the acceptance angle of the reflection beam from the first surface of the transparent base is varied in the range of x−30° to x+30°, and the luminance of the third light (or x° effective total reflection beam) reflected from the first surface is measured.

For example, in the case in which the third light is irradiated on the first surface side of the transparent base in the direction inclined by 20° with respect to the thickness direction of the transparent base, the acceptance angle of the reflection beam from the first surface of the transparent base is varied in the range of −10° to +50°, and the luminance of the third light reflected from the first surface is measured to obtain the luminance of the 20° effective total reflection beam.

In addition, in the case in which the third light is irradiated on the first surface side of the transparent base in the direction inclined by 45° with respect to the thickness direction of the transparent base, the acceptance angle of the reflection beam from the first surface of the transparent base is varied in the range of 15° to 75°, and the luminance of the third light reflected from the first surface is measured to obtain the luminance of the 45° effective total reflection beam.

(Step S340)

Next, the x° effective reflected image diffusion index value R_{bx°} at the first surface is computed based on the formula (2) described above, using the measured luminances.

In other words, the 20° effective reflected image diffusion index value R_{b20°} at the first surface can be computed based on the formula (3) described above. In addition, the 45° effective reflected image diffusion index value R_{b45°} at the first surface can be computed based on the formula (4) described above.

The 20° effective reflected image diffusion index value R_{b20°} at the second surface, and the 45° effective reflected image diffusion index value R_{b45°} at the second surface can be obtained similarly by the third method described above.

The x° effective reflected image diffusion index value R_{bx°} (x is 20 or 45 in this example) of each target surface, that is obtained by the third method described above, may be used as the index representing the reflected image diffusion at the target surface, in the state in which the effects of the reflected image diffusion at the non-target surface are eliminated.

Particularly in the case in which the relationship (1) described above stands between the 20° effective reflected image diffusion index value R_{b20°} and the 45° effective reflected image diffusion index value R_{b45°}, it is indicated that the reflected image diffusion viewed at the 20° angle is higher than the reflected image diffusion viewed at the 45° angle. In a case in which first and second samples of the transparent base have the same transmitted image clarity and the first sample has the 20° effective reflected image diffusion index value R_{b20°} and the second sample has the 45° effective reflected image diffusion index value R_{b45°}, the reflected image diffusion is higher for the first sample having the 20° effective reflected image diffusion index value R_{b20°} when the relationship (1) described above is satisfied. Hence, at the actual viewing angle (in a vicinity of 0° with respect to the thickness direction of the transparent base) at which the display image or the like is viewed, the first sample can provide a transparent base having both a satisfactory reflected image diffusion (that is, a high reflected image diffusion index value R) and a satisfactory transmitted image clarity (that is, a low resolution index value T). There is a tendency for the relationship (1) not to be satisfied when the target surface that is the evaluation target has a reflection surface with a large texture (for example, a large concavo-convex shape or undulation), and for the relationship (1) to be satisfied when the target surface that is the evaluation target has a reflection surface with a small texture (for example, a small concavo-convex shape or undulation). As described above, the relationship (1) reflects the differences in the textures or the surface shapes of the target surface of the samples of the transparent base.

The measurements described above may easily be performed using an existing goniometer (or goniophotometer) on the market.

Next, a description will be given of examples according to certain embodiments of the present invention.

### Example ex1

In this example ex1, the texture is formed on both surfaces of a glass substrate, by procedures described hereunder.

First, a glass substrate having a vertical length of 100 mm, a horizontal length of 100 mm, and a thickness of 0.7 mm is prepared. The glass substrate may be formed by soda lime glass, and no chemical strengthening is performed on the glass substrate.

Next, this glass substrate is immersed in a frosting liquid for three (3) minutes in order to perform an auxiliary etching. For example, the frosting liquid used in the auxiliary etching includes 2 wt % of hydrogen fluoride and 3 wt % of potassium fluoride. Further, after cleaning the glass substrate, the cleaned, glass substrate is immersed in a solution for eighteen (18) minutes in order to perform a main etching. For example, the solution used in the main etching includes 7.5 wt % of hydrogen fluoride and 7.5 wt % of hydrogen chloride. As a result, a glass base according to the example ex1, having similar textures formed on both surfaces thereof, is obtained.

### Examples ex2 through ex12

Glass bases according to examples ex2 through ex12, having the textures formed on both surfaces thereof, are obtained by a method similar to that used to obtain the glass base according to the example ex1. In the examples ex2 through ex12, however, conditions of the auxiliary etching and/or the main etching are varied, in order to manufacture eleven (11) kinds of glass bases having textures different from that of the glass base according to the example ex1, formed on both surfaces thereof.

(Evaluation)

The glass bases manufactured by the method described above are evaluated in the following manner.

(Surface Roughness Measurement)

A surface roughness (or surface texture) of the glass bases according to the examples ex1 through ex12 is measured using a surface texture measuring instrument (PF-60 manufactured by Mitaka Kohki Co., Ltd.). The root mean square roughness R_{q} of the surface roughness on the surface, the average length R_{Sm} of the surface roughness curve element on the surface, and an arithmetic average roughness Ra are used as measuring indexes. These measuring indexes may be measured according to the method proposed in JIS, B0601: 2001, for example.

The results obtained for each of the glass bases according to the examples ex1 through ex12 are tabulated in a “measured results of surface roughness” column of the following Table 1.

TABLE 1

| | | | | x° | | |
|---|---|---|---|---|---|---|
| | Measured | | | Substantially | | |
| | Results | | | Reflected | | |
| | of Surface | | | Image | | |
| | Roughness | | Resolution | Diffusion Index | | |
| | R_{q} | R_{Sm} | Index | Value R_{bx°} | | |
| Example | (μm) | (μm) | Value T | R_{b20°} | R_{b45°} | R_{b20°} − R_{b45°} |
| ex1 | 0.21 | 13.9 | 0.17 | 0.9 | 0.82 | 0.07 |
| ex2 | 0.19 | 15.2 | 0.14 | 0.86 | 0.79 | 0.07 |
| ex3 | 0.17 | 15.3 | 0.11 | 0.80 | 0.58 | 0.22 |
| ex4 | 1.55 | 114 | 0.87 | 0.95 | 0.95 | 0 |
| ex5 | 0.95 | 105 | 0.80 | 0.93 | 0.93 | 0.01 |
| ex6 | 0.55 | 106 | 0.62 | 0.88 | 0.88 | 0.01 |
| ex7 | 0.70 | 63.9 | 0.82 | 0.93 | 0.93 | 0 |
| ex8 | 0.24 | 58.4 | 0.51 | 0.85 | 0.86 | −0.01 |
| ex9 | 0.16 | 41.2 | 0.30 | 0.80 | 0.80 | 0 |
| ex10 | 0.98 | 148 | 0.78 | 0.92 | 0.91 | 0 |
| ex11 | 0.13 | 85.4 | 0.20 | 0.64 | 0.60 | 0.03 |
| ex12 | 0.3 | 44.9 | 0.57 | 0.91 | 0.91 | 0 |

Approximately the same results are obtained at the first and second surface in each of the glass bases according to the examples ex1 through ex12. Accordingly, Table 1 only illustrates the results obtained at one of the first and second surfaces.

It may be seen from Table 1 that the textures on on the first and second surfaces of the glass bases according to the examples ex1 through ex3 are relatively small and are formed at a period that is shorter when compared to the period of the textures formed on the first and second surfaces of the glass bases according to the examples ex4 through ex12.

(Measurement of Resolution Index Value T)

The resolution index value T of each of the glass bases according to the examples ex1 through ex12 is measured by the method described above in conjunction with FIG. 2. A goniometer (GC500L manufactured by Nippon Denshoku Industries Co., Ltd.) is used for this measurement.

The resolution index value T is measured with respect to the first and second surfaces of the glass bases. In addition, the larger one of the two measured resolution index values T obtained for each glass base is regarded as the resolution index value T (Tₘₐₓ) of each glass base.

The resolution index values T obtained for each of the glass bases according to the examples ex1 through ex12 are tabulated in a “resolution index value T” column of Table 1.

As may be seen from Table 1, relatively small resolution index values T (Tₘₐₓ) of less than 0.2 are obtained for the glass bases according to the examples ex1 through ex3. Hence, it may be seen that the glass gases according to the examples ex1 through ex3 can obtain a satisfactory transmitted image clarity.

(Evaluation of R_{b20°}−R_{b45°})

The x° effective reflected image diffusion index value R_{bx°} (x is 20 or 45 in this example) of the glass bases according to the examples ex1 through ex12 are measured by the method described above in conjunction with FIG. 7. A goniometer (GC500L manufactured by Nippon Denshoku Industries Co., Ltd.) is used for this measurement.

The x° effective reflected image diffusion index value R_{bx°} is measured with respect to the first surface in a state in which black ink is coated on the second surface to absorb light, for the glass bases according to the examples ex1 through ex12.

Next, the x° effective reflected image diffusion index value R_{bx°} (x is 20 or 45 in this example) measured with respect to the first surface of the glass bases according to the examples ex1 through ex12 is used to compute a value of R_{b20°}−R_{b45°}.

The 20° effective reflected image diffusion index value R_{b20°} and the 45° effective reflected image diffusion index value R_{b45°} measured for the glass bases according to the examples ex1 through ex12 are illustrated in a “x° effective reflected image diffusion index value 1:6.” column of Table 1. In addition, the value of R_{b20°}−R_{b45°} computed for the glass bases according to the examples ex1 through ex12 is illustrated in a “R_{b20°}−R_{b45°}” column of Table 1.

Evaluations similar to those described above are performed with respect to the second surface of the glass bases according to the examples ex1 through ex12, in a state in which the black ink is coated on the first surface to absorb light. As a result, it is confirmed that the evaluation results obtained with respect to the second surface are approximately the same as the above described evaluation results obtained with respect to the first surface.

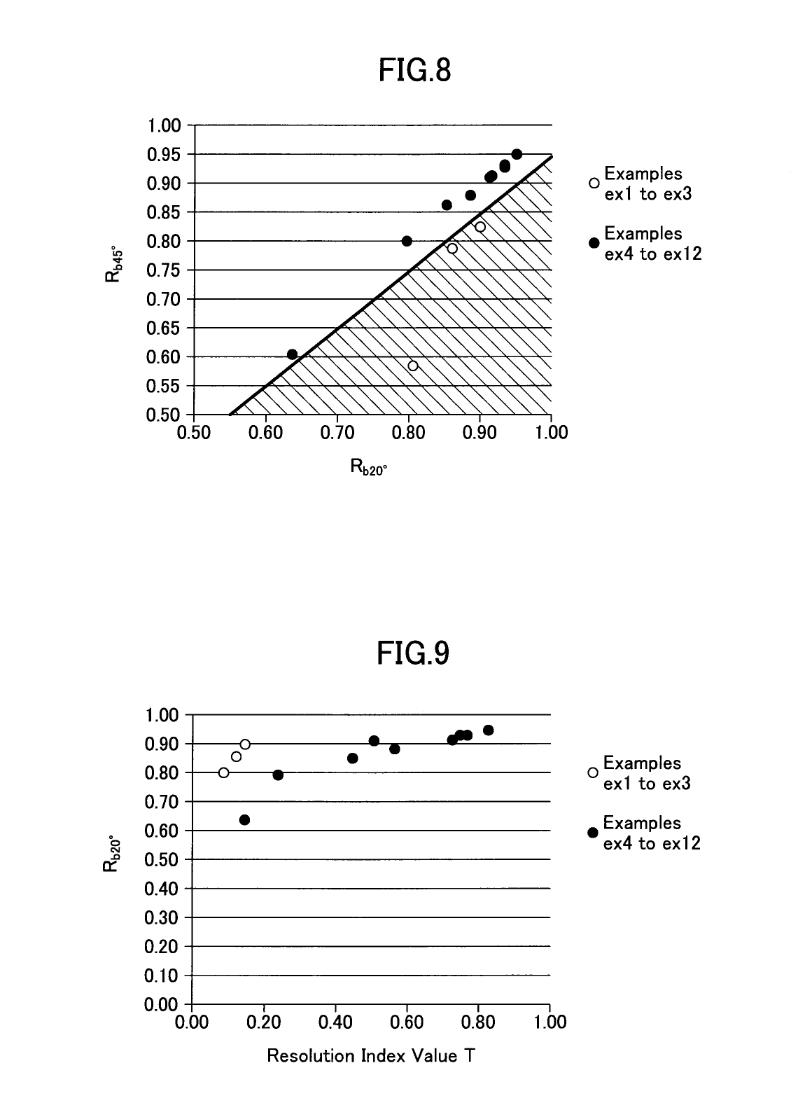

FIG. 8 is a graph illustrating a plot of a relationship (R_{b20°}, R_{b45°}), obtained for the glass bases according to the examples ex1 through ex12, in regions represented by R_{b20°} (abscissa) and R_{b45°} (ordinate). Plots for the examples ex1 through ex3 are indicated by symbols “∘”, and plots for the examples ex4 through ex12 are indicated by symbols “”.

In FIG. 8, a straight, bold solid line indicates a relationship R_{b45°}=R_{b20°}+0.05. Accordingly, a region S indicated by hatchings in FIG. 8 corresponds to a region in which the relationship (1) described above is satisfied.

From FIG. 8, it may be seen that the glass bases according to the examples ex4 through ex12 have the relationship (R_{b20°}, R_{b45°}) in a region in which the relationship (1) described above is not satisfied. On the other hand, it may also be seen that the glass bases according to the examples ex1 through ex3 have the relationship (R_{b20°}, R_{b45°}) in the region in which the relationship (1) described above is satisfied.

FIG. 9 is a graph illustrating a relationship between the resolution index value T (abscissa) and the reflected image diffusion index value R_{b20°} (ordinate) of the effective reflected image, obtained for the glass bases according to the examples ex1 through ex12. Plots for the examples ex1 through ex3 are indicated by symbols “∘”, and plots for the examples ex4 through ex12 are indicated by symbols “”.

From FIG. 9, it may be seen that each of the plots for the glass bases according to the examples ex1 through ex3 is located in a region on the upper left side with respect to each of the plots for the glass bases according to the examples ex4 through ex12. In other words, it may be seen that the resolution index value T is small and the 20° effective reflected image diffusion index value R_{b20°} is large for the glass bases according to the examples ex1 through ex3, when compared to those of the glass bases according to the examples ex4 through ex12.

From these results, it may be regarded that the glass bases according to the examples ex1 through ex3 having the surface with the value of R_{b20°}−R_{b45°} satisfying the relationship (1) described above can exhibit a satisfactory transmitted image clarity and a satisfactory reflected image diffusion, when compared to the glass bases according to the examples ex4 through ex12 having the surface with the value of R_{b20°}−R_{b45°} not satisfying the relationship (1) described above.

### Examples ex21 through ex23

Glass bases according to examples ex21 through ex23, having the textures formed on both surfaces thereof, are obtained by a method similar to that used to obtain the glass base according to the example ex1.

In the examples ex21 through ex23, however, conditions of the auxiliary etching and/or the main etching are varied, in order to manufacture three (3) kinds of glass bases having textures different from that of the glass base according to the example ex1, formed on both surfaces thereof.

The conditions of the auxiliary etching and the main etching for the glass base according to the example ex23 are the same as those for the glass base according to the example ex21. However, when manufacturing the glass base according to the examiner ex23, a masking film is adhered on the second surface prior to performing the auxiliary etching and the main etching, in order to form the texture only on the first surface.

(Evaluation)

(Measurement of Surface Roughness & Measurement of Resolution Index Value T)

The measurement of the surface roughness and the measurement of the resolution index value T for the glass bases according to the examples ex21 through ex23 are performed by the same methods as the measurements performed for the glass bases according to the examples ex1 through ex12 described above. In the case of the glass base according to the example ex23, the first surface is used as the target surface, and the measurement of the surface roughness and the measurement of the resolution index value T are performed with respect to the first surface.

The results obtained for each of the glass bases according to the examples ex21 through ex23 are tabulated in a “measured results of surface roughness” column of the following Table 2. In addition, the resolution index values T obtained for each of the glass bases according to the examples ex21 through ex23 are tabulated in a “resolution index value T” column of Table 2.

TABLE 2

| | Measured | | | | |
|---|---|---|---|---|---|
| | Results | | | | |
| | of Surface | | | | Reflected |
| | Roughness | | Resolution | | Image |
| | R_{q} | R_{Sm} | Index | | Diffusion |
| Example | (μm) | (μm) | Value T | R_{b20°}-R_{b45°} | Index Value R |
| ex21 | 0.13 | 19.8 | 0.09 | Satisfies | 0.73 |
| | | | | Relationship (1) | |
| ex22 | 0.16 | 41.2 | 0.20 | Does not Satisfy | 0.62 |
| | | | | Relationship (1) | |
| ex23 | 0.12 | 19.2 | 0.07 | — | 0.39 |

As may be seen from Table 2, relatively small resolution index values T (Tₘₐₓ) of less than 0.1 are obtained for the glass bases according to the examples ex21 and ex23. Hence, it may be seen that the glass gases according to the examples ex21 and ex23 can obtain a satisfactory transmitted image clarity. On the other hand, the resolution index value T (Tₘₐₓ) obtained for the glass base according to the example ex22 is approximately 0.2, and it may be seen that the transmitted image clarity for the glass base according to the example ex22 is not as satisfactory as the resolution index values T (Tₘₐₓ) for the glass bases according to the examples ex21 and ex23.

(Evaluation of R_{b20°}−R_{b45°})

The x° effective reflected image diffusion index value R_{bx°} (x is 20 or 45 in this example) of the glass bases according to the examples ex21 through ex23 are measured by a method similar to that used for the glass bases according to the examples ex1 through ex12.

As a result, it is confirmed that the relationship of R_{b20°} and R_{b45°} satisfies the relationship (1) described above for both the first and second surfaces of the glass base according to the example ex21. On the other hand, it is confirmed that the relationship of R_{b20°} and R_{b45°} does not satisfy the relationship (1) described above for neither one of the first and second surfaces of the glass base according to the example ex22.

(Measurement of Reflected Image Diffusion Index Value)

The reflected image diffusion index values R of the glass bases according to the examples ex21 through ex22 are measured by the method described above in conjunction with FIG. 5. A goniometer (GC500L manufactured by Nippon Denshoku Industries Co., Ltd.) is used for this measurement.

The reflected image diffusion index value R is measured for each of the first and second surfaces of the glass bases according to the examples ex21 and ex22. In addition, a smaller one of the two reflected image diffusion index values R obtained for each of the glass bases according to the examples ex21 and ex22 is used as the reflected image diffusion index value R (Rₘᵢₙ) of the glass base.

On the other hand, with respect to the glass base according to the example ex23, the measurement is performed with respect to the first surface that is formed with the texture and is located on the detector side, in order to obtain the reflected image diffusion index value R of the glass base.

The reflected image diffusion index values R obtained for each of the glass bases according to the examples ex21 through ex23 are tabulated in a “reflected image diffusion index value R” column of Table 2.

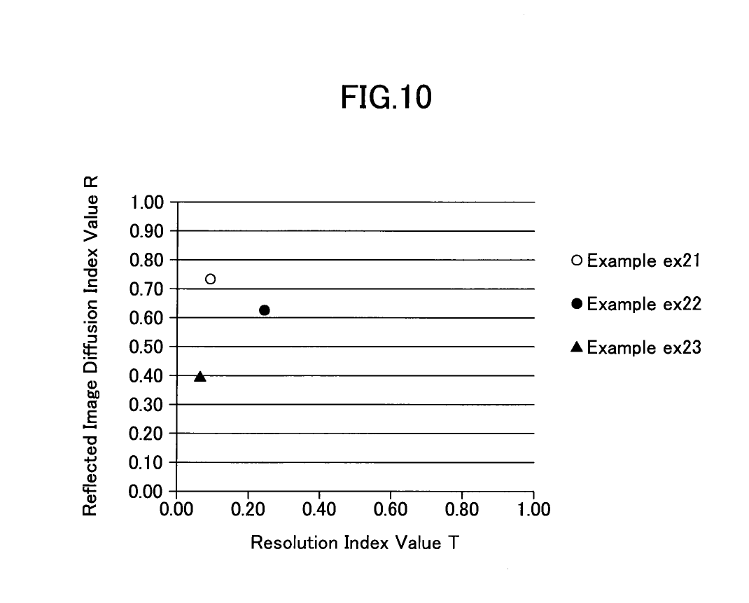

FIG. 10 is a graph illustrating a relationship between the resolution index value T (abscissa) and the reflected image diffusion index value R (ordinate) of the reflected image, obtained for the glass bases according to examples ex21 through ex23. Plots for the example ex21 are indicated by symbols “∘”, plots for the example ex22 are indicated by symbols “”, and plots for the example ex23 are indicated by symbols “▴”.

From FIG. 10, it may be seen that each of the plots for the glass base according to the example ex21 is located in a region on the upper left side with respect to each of the plots for the glass bases according to the examples ex22 and ex23. In other words, it may be seen that the resolution index value T is small and the reflected image diffusion index value R is large for the glass base according to the example ex21, when compared to those of the glass bases according to the examples ex22 and ex23. Hence, the glass base according to the example ex21 exhibits a satisfactory transmitted image clarity and a satisfactory reflected image diffusion.

Accordingly, by forming the texture on the first and second surfaces of the glass base so that both the first and second surfaces satisfy the relationship (1) described above, it is confirmed that a glass base having a transmitted image clarity and a reflected image diffusion that are both more satisfactory than those of the conventional case can be provided.

Certain embodiments may be utilized as a cover member or the like that is provided on various kinds of display devices, such as an LCD (Liquid Crystal Display) device, an OLED (Organic Light Emitting Diode or) device, a PDP (Plasma Display Panel), and a tablet type display device.

According to certain embodiments, it is possible to provide a transparent base which can simultaneously satisfy the transmitted image clarity and the reflected image diffusion, when compared to the related art.

Further, the present invention is not limited to these embodiments and practical examples, but various variations, modifications, or substitutions may be made without departing from the scope of the present invention.

What is claimed is:

1. A transparent base comprising:
a first surface that is textured; and
a second surface that is textured and is located on an opposite side of the transparent base from the first surface,
wherein a 20° effective reflected image diffusion index value R_{b20°} and a 45° effective reflected diffusion index value R_{b45°} used for evaluation of the first and second surfaces satisfy a relationship R_{b20°}−R_{b45°}>=0.05,
wherein an x° effective reflected image diffusion index value R_{bx°} of a target surface that is to be evaluated, in a state in which a non-target surface that is not an evaluation target of the transparent base has been subjected to a treatment that prevents reflection of light, is computed from a formula R_{bx°}=(L_{strx°}−L_{srrx°})/L_{strx°} by
irradiating light in a direction inclined by x° with respect to a thickness direction of the transparent base from the target surface side of the transparent base,
measuring a luminance of a regular reflection beam reflected from the target surface,
varying an acceptance angle of the regular reflection beam reflected from the target surface in a range of x−30° to x+30°, and
measuring the luminance of a total reflection beam reflected from the target surface,
wherein the thickness direction of the transparent base refers to a direction in which a thickness of the transparent base is taken or measured, R_{bx°} denotes an x° effective reflected image diffusion index value, L_{strx°} denotes a luminance of the x° effective total reflection beam, L_{srrx°} denotes a luminance of the x° effective regular reflection beam, and x is 20 or 45.

2. The transparent base as claimed in claim 1, wherein a resolution index value T of the transparent base is less than 0.2,
wherein a resolution index value T1 of the first surface is computed based on a formula T1=(Lₜₜ−L_{t0°})/Lₜₜ by
irradiating light from the second surface in a direction parallel to the thickness direction of the transparent base,
measuring a luminance L_{t0°} of the 0° transmitted light transmitted through the first surface in the direction parallel to the thickness direction of the transparent base,
varying an acceptance angle of the light irradiated from the second surface with respect to the first surface in a range of −30° to +30°, and
measuring a luminance Lₜₜ of total reflected light transmitted from the first surface,
wherein a resolution index value T2 of the second surface is computed similarly to the resolution index value T1, and
wherein the resolution index value T is a larger one of the resolution index values T1 and T2.

3. The transparent base as claimed in claim 2, wherein the resolution index value T of the transparent base is less than 0.15.

4. The transparent base as claimed in claim 1, wherein an average length R_{Sm} of a surface roughness curve element on at least one of the first and second surfaces is 25 μm or less, and a root mean square roughness R_{q} of the at least one of the first and second surfaces roughness on the surface is 0.3 μm or less.

5. The transparent base as claimed in claim 4, wherein a resolution index value T of the transparent base is less than 0.2,
wherein a resolution index value T1 of the first surface is computed based on a formula T1=(Lₜₜ−L_{t0°})/Lₜₜ by
irradiating light from the second surface in a direction parallel to the thickness direction of the transparent base,
measuring a luminance L_{t0°} of the 0° transmitted light transmitted through the first surface in the direction parallel to the thickness direction of the transparent base,
varying an acceptance angle of the light irradiated from the second surface with respect to the first surface in a range of −30° to +30°, and
measuring a luminance Lₜₜ of total reflected light transmitted from the first surface,
wherein a resolution index value T2 of the second surface is computed similarly to the resolution index value T1, and
wherein the resolution index value T is a larger one of the resolution index values T1 and T2.

6. The transparent base as claimed in claim 5, wherein the resolution index value T of the transparent base is less than 0.15.

7. The transparent base as claimed in claim 1, wherein the transparent base is made of glass.
